(19) United States
(12) Patent Application Publication
(10) Pub. No.: US 2003/0025786 A1
(43) Pub. Date: Feb. 6, 2003

(54) Method and system for saving and applying a video address from a video conference

(75) Inventor: Kirk A. Norsworthy, Austin, TX (US)

Correspondence Address: Robert W. Holland, Baker Botts L.L.P., Suite 600, 2001 Ross Avenue, Dallas, TX, 75201-2980, US

(73) Assignee: VTEL Corporation

(21) Appl. No.: 09/919,535

(22) Filed: Jul. 31, 2001

(51) Int. Cl. H04N 7/14

(52) U.S. Cl. 348/14.08; 348/14.01

(57) ABSTRACT

A system and method for generating address book entires from a captured video frame simplifies user interaction with a video network. During an established video call, a user captures a frame of the video stream and stores the frame as an icon in an address book along with associated call configuration information. To initiate a video to call to the participant or location associated with the frame, the user selects the icon and the address book initiates the video call using the stored call configuration.

### TECHNICAL FIELD OF THE INVENTION

This invention relates in general to video conferencing, and more particularly to a method and system for saving and applying a video address from a frame of a video conference.

### BACKGROUND OF THE INVENTION

Video conferencing has grown into an increasingly popular communication medium because of the advantages that it offers over audio only telephone conferences. For instance, video conferencing adds a personal touch not available from a phone call, including improved communication through body language and facial expression. Participants in a video conference are able to reference visual images, such as charts, graphs and presentations, and are even able to exchange data such as spread sheets. Further, video conferencing equipment has become more common as the equipment has decreased in cost, and the cost of establishing video connections has dropped with increases in network bandwidth available for supporting video conferences.

Although video conferences have become more common, the complexity associated with the process of establishing a video conference has presented a substantial difficulty which hampers wide spread acceptance. Typically, a participant must have some computer skills and some understanding of video conferencing equipment in order to arrange and establish a video conference. For instance, a typical conference between several video endpoint devices may depend on the use of an array of equipment including different types of video endpoints, MCUs, gateways, gatekeepers and network interfaces.

A user faced with the complexity of establishing a video conference is easily tempted to pick up a telephone instead. Phone numbers are easy to look up and dial and are typically stored in address books such as Microsoft Outlook. Many phones come equipped with one-touch speed dialers that allow a user to touch a button and establish a phone conversation. One vendor, the TeleFace Photo Phone, even places pictures on keys so that a user can simply touch a picture to establish a phone conversation with the individual in the picture. Given the simplicity of establishing a phone conversation, many users choose the telephone to communciate, even when a video conference is available and advantageous, if only to avoid dealing with the complexity of establishing the video conference.

### SUMMARY OF THE INVENTION

Therefore a need has arisen for a system and method which reduces the complexity of establishing a video conference.

A further need has arisen for a system and method which allows a user to save video conference information during a video conference for application in establishing a video conference at a future time.

A further need has arisen for a system and method which provides a user with a visual depiction as an interface to initiate a video conference with the person or location associated with the visual depiction.

In accordance with the present invention, a system and method are provided which reduce the disadvantages and problems previously associated with establishing a video conference. During a video conference, a video representation of a participant and/or a location are captured, such as by capturing a frame of the video conference, so that the participant and/or location is associated with the video call configuration, such as the calling number, and stored for future application to establish a video conference with the individual or location.

More specifically, during a video conference between first and second video endpoints, an address book user interface is presented at the first endpoint. The address book user interface provides a user associated with the first endpoint with an option to capture a video frame and store the frame in an address book storage medium along with call configuration information associated with the captured frame. For instance, the user may use a mouse to select an icon from a graphical user interface presented on the video endpoint or an associated computing device, such as a personal computer. Alternatively, the user may access the address book through a keyboard interface to initiate storage of the frame. Upon capture of the frame, the address book stores the frame as a visual depiction along with a video call configuration associated with the second video endpoint, such as the number to call the second endpoint or the network address of the second endpoint.

To establish a video call from the first endpoint to the second endpoint, the user selects the frame associated with the second endpoint from the address book. For instance, the frame is presented as an icon on the first video endpoint or a computing device associated with the first video endpoint. Alternatively, the user accesses the address book through a keyboard to select the second video endpoint with the visual depiction of the second video endpoint provided as a guide. The address book then initiates a video call to the second video endpoint using the stored video call configuration. For instance, the address book dials the number or contacts the network address associated with the second video end point.

In one alternative embodiment, the address book interface supports selection of one or more frames for plural endpoints during a multi-call video conference. For instance, the user can select one or plural endpoints for inclusion in the address book. Alternatively, the user can save a multi-call configuration so that the same video call may be initiated from the address book. Thus, for instance, if the participants of a multi-endpoint video call desire to adjourn for a period of time and then resume the video call, the address book interface allows the user to store the call configuration along with visual depictions of the participants so that a user can select the participants to re-initiate the video call.

The present invention provides a number of important technical advantages. One important technical advantage is that the complexity of establishing a video conference is greatly reduced. A user saves a video call configuration associated with an existing video call so that user can re-establish the video call by accessing and applying the saved call configuration. In addition to simplifying the process of establishing a video call, the user also saves time and reduces the possibility of errors such as establishing a video conference with an unintended site.

Another important technical advantage of the present invention is that it provides a simplified interface for a user to save a video call configuration. A user simply selects a frame during a video conference to have the call configuration associated with that frame saved in an address book. When the user desires to re-establish a video call with the individual or site associated with the saved frame, the user simply selects the frame from the address book.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 depicts a block diagram of a video endpoint interfaced with an address book; and

FIG. 2 depicts a flow diagram of a process for associating a captured video frame with a video call configuration.

### DETAILED DESCRIPTION OF THE INVENTION

Preferred embodiments of the present invention are illustrated in the figures, like numerals being used to refer to like and corresponding parts of the various drawings.

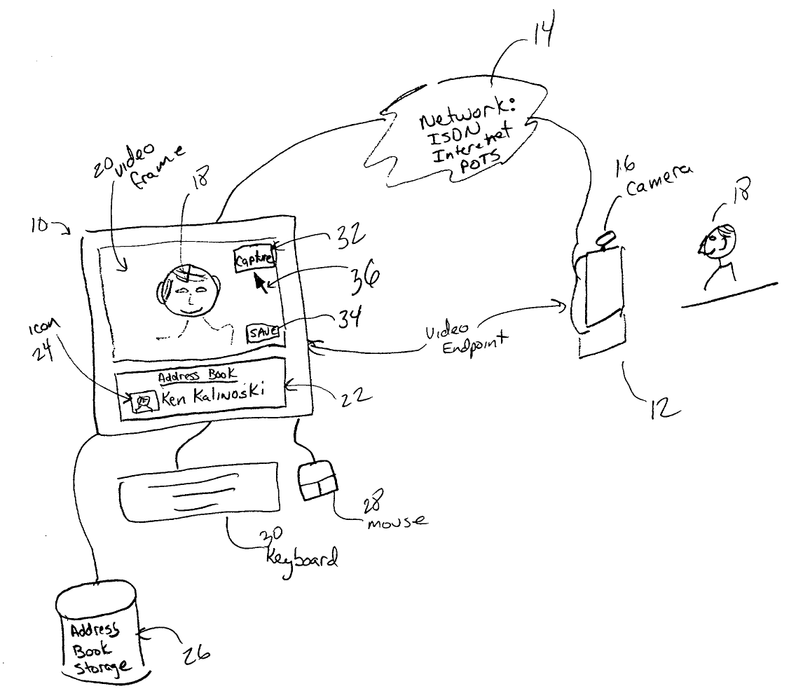

Referring now to FIG. 1, a block diagram depicts an address book system incorporated in video conferencing endpoint 10. Video endpoint 10 has an established video conference call with video endpoint 12 through network 14. A camera 16 associated with end point 12 sends video data of a participant 18 through network 14 for display as a series of video frames 20 by endpoint 10. Network 14 is any network having sufficient bandwidth to support a video conference, including the Internet, a business intranet, a local area network, a wide area network an ISDN network, and the public network. Further, in alternative embodiments in which a greater number of video endpoints are having a video conference, the network supports other video network devices that enable the video call, such as multi-call units, gateways and gatekeepers as well as network devices such as routers.

Video endpoint 10 displays the image of participant 18 in video frames 20 for viewing by a user associated with endpoint 10. An address book 22 is also displayed on endpoint 10 and includes an icon 24 that has associated address information, in this case the name of the individual depicted by icon 24, Ken Kalinoski. Address book 22 interfaces with an address book storage medium 26 which stores video call configuration information associated with icon 24, such as the ISDN or IP address associated with Ken Kalinoski. The user of endpoint 10 interacts with address book 22 through a mouse 28 or a keyboard 30. For instance, to initiate a video call to Ken Kalinoski, the user selects icon 24 with mouse 28 and the address book initiates a video call using the video call configuration associated with Ken Kalinoski from address book storage medium 26. In alternative embodiments, address book 22 is supported by a separated associated computing device, such as a personal computer, and may be accessible through network 14, thus allowing central storage and access by individuals of their own personal address book, such as an Outlook address book that includes the video address book information, or a common address book that others on the network can access as well.

Video frame 20 includes a capture icon 32, a save icon 34 and a mouse arrow 36 that allow a user associated with endpoint 10 to add the established video call to the user's address book 22. For instance, the user selects capture icon 32 with mouse arrow 36 to capture the video frame displayed on endpoint 10. Once captured, the frame is displayed in address book 22 as an icon 24 and a cursor allows the user to input address information. The user then selects the save icon 34 to save the icon and associated address information in the user's address book. For instance, to save the address associated with participant 18, Ken Kalinoski, the user captures the frame of Ken Kalinoski with capture icon 32 and then inputs the name Ken Kalinoski next to icon 24. When the user saves the captured frame with save icon 34, address book 22 saves the video configuration associated with the video call to participant 18.

In alternative embodiments, the address book operates with multiple call video conferences by allowing the user to select one or more participants for inclusion in address book 22. For instance, the user selects one of plural participants for inclusion in the address book by establishing a video frame for that participant and then capturing and saving the call configuration to that participant. Alternatively, a user may save a video call configuration that includes multiple endpoints. For instance, if a user of endpoint 10 wishes to re-establish a multiple endpoint call at a future time, the user stores the video call configuration for the complete call along with icons associated with each participant. In such a call, the video call configuration information may include supporting video devices, such as gateways and MCU's, so that the user can re-establish the same call configuration by selecting the multi-call icon.

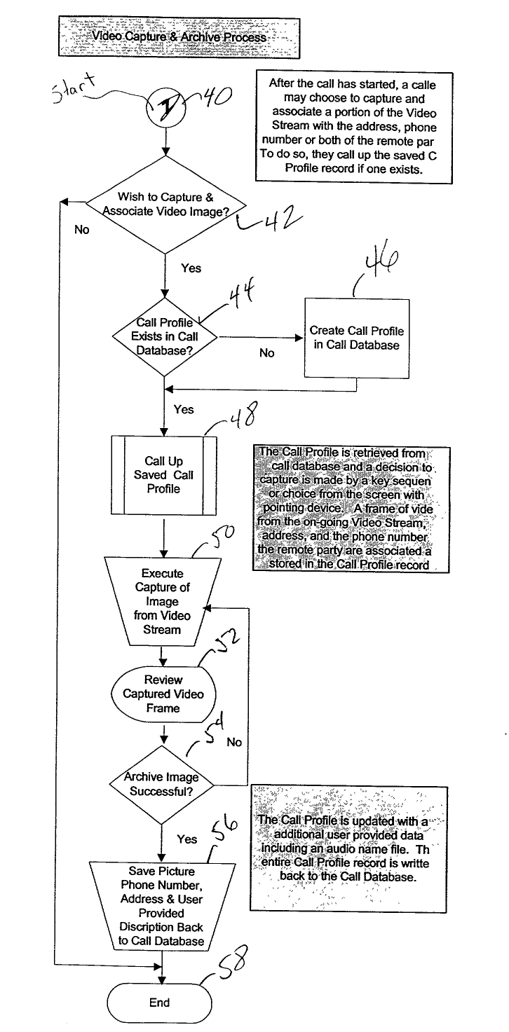

Referring now to FIG. 2, a flow diagram depicts a process for capturing and archiving a video frame in an address book along with video call configuration information for the endpoint associated with the address. After a video call is established, a user may choose to capture and associate a portion of the video stream with the address, phone number and/or other video call configuration information of remote participants of the video call. To do so, the user calls up a saved profile for the participant or location that the user wishes to add to the address book, or, if no profile exists, the user establishes a new profile. The call profile is retrieved from a call profile database and the user initiates capture of a desired frame to associate with the call profile, such as by selecting a capture icon with a mouse. The captured frame and call configuration information from the call profile, such as the address and phone number of the captured participant, are associated and stored in the call profile record. The user may then update the call profile record with additional information, such as the captured participant's name, and the call profile is written back into the call database.

The process starts at step 40 with an established video call. At step 42, the user is presented with an option to capture and associate a video frame image with a call configuration and address. If the user elects not to save the address, the process ends at step 58. If the user elects to save the address, the process proceeds to step 44 where a determination is made of whether a call profile exists in a call database. For instance, when the call is established, the call configuration is typically available to the endpoints as a call profile, either through local memory or access to the network. If no call profile is available, then at step 46, the user is provided with an option to enter a call profile in the call database.

Once a call profile is available, at step 48 the call profile is called up for use by the address book. At step 50, the user executes capture of an image from the video stream associated with the call profile. At step 52, the user is provided with an opportunity to review the captured image. At step 54, the user determines whether the archived video frame is satisfactory. If not, the user may elect to return to step 50 to store a different video frame. If the archive of the frame was successful and satisfactory to the user, then at step 56, the address book stores the frame and call configuration, such as the phone number, address and user provided description, back to the call database.

Once an address is stored in the address book, the user may access the address to modify the address information. For instance, if a video endpoint device is moved from one location to another, the staff responsible to moving the video endpoint device can lookup address book entries associated with the device and modify the entries to reflect the endpoint's new location. In addition, where an endpoint location is represented by an icon, as opposed to an individual, the staff can update the icon to reflect the new location in the address book. In one embodiment, a video network address book is automatically updated when endpoint devices are moved to various locations by associating the address read by the network for the endpoint device with a pre-stored icon. For instance, a conference room having a predefined IP address and icon will result in an automatic update to the address book when the network detects a video device at the IP address. Thus, other sites in the network may initiate a video call to the conference room by selecting the icon from a centralized address book.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A method for generating an address book from a frame of a video conference, comprising:
capturing a frame of a first video conference at a first endpoint, the frame including an image generated by a second endpoint and an address associated with the second endpoint;
storing the frame in an address book at the first endpoint; and
accessing the frame at the first endpoint to initiate a second video conference with the second endpoint.

2. The method of claim 1, wherein the storing comprises associating the frame with a number stored in the address book, the number used to identify the second endpoint.

3. The method of claim 1, further comprising:
creating an address icon with the image from the frame; and
selecting the address icon with a mouse coupled to the first endpoint to access the frame.

4. The method of claim 1, further comprising:
creating an address icon with the image from the frame; and
touching the address icon on a display coupled to the first endpoint to acess the frame.

5. The method of claim 1, wherein the capturing comprises entering a key sequence on a keyboard coupled to the first endpoint when the image is displayed at the first endpoint.

6. The method of claim 1, wherein the capturing comprises selecting a capture icon with a mouse coupled to the first endpoint when the image is displayed at the first endpoint.

7. The method of claim 1, wherein the address comprises an Internet Protocol (IP) address or an Integrated Services Digital Network (ISDN) address.

8. A method for generating an address book from an image received during a video conference, comprising:
generating an image at a first endpoint during a video conference with a second endpoint, the image including an address associated with the first endpoint;
communicating the image from the first endpoint to the second endpoint;
associating the image with a number used by the second endpoint to identify the first endpoint;
storing the image and the number in an address book on the second endpoint; and
accessing the image at the second endpoint to initiate a second video conference with the first endpoint.

9. The method of claim 8, further comprising:
creating an address icon with the image from the frame; and
selecting the address icon with a mouse coupled to the second endpoint to access the frame.

10. The method of claim 8, wherein the generating comprises capturing a frame transmitted from the first endpoint to the second endpoint.

11. The method of claim 8, wherein the video conference comprises a video stream, an audio stream and a data stream.

12. The method of claim 11, wherein the commmunicating comprises inserting the image into the data stream communicated from the first endpoint to the second endpoint.

13. The method of claim 8, wherein the number comprises a telephone number.

14. A video endpoint, comprising:
an interface operable to couple to a network;
a storage medium;
a processing resource coupled to the storage medium and the interface, the processing resource operable to:
capture a frame of a first video conference, the frame including an image generated by a remote endpoint and an address associated with the remote endpoint;
store the frame in an address book in the storage medium; and
initiate a second video conference with the remote endpoint by accessing the frame.

15. The video endpoint of claim 14, further comprising the processing resource operable to associate the frame with a number stored in the address book, the number used to identify the remote endpoint.

16. The video endpoint of claim 14, further comprising:
a first output connector coupled to the processing resource; and
a second output connector coupled to the processing resource.

17. The video endpoint of claim 16, further comprising:
a keyboard coupled to the first output connector;
a display coupled to the second output connector; and
the frame captured by entering a key sequence on the keyboard when the image is displayed on the display.

18. The video endpoint of claim 16, further comprising:
a mouse coupled to the first output connector;
a display coupled to the second output connector; and
the frame captured by selecting a capture icon when the image is displayed on the display.

19. The video endpoint of claim 14, further comprising:
the processing resource operable to create an address icon; and
the second video conference initiated by selecting the address icon.

20. The video endpoint of claim 14, wherein the network comprises an Internet Protocol (IP) network, an Integrated Services Digital Network (ISDN), an Asynchronous Transfer Mode (ATM) network or a Frame Relay network.
